(19) United States
(12) Patent Application Publication
(10) Pub. No.: US 2015/0088400 A1
(43) Pub. Date: Mar. 26, 2015

(54) ACTUATING DRIVE FOR AN AIR PASSAGE APPARATUS AND METHOD FOR CONTROLLING AN ACTUATING DRIVE

(71) Applicant: Brose Fahrzeugteile GmbH & Co. Kommanditgesellscha ft, Hallstadt, Hallstadt (DE)

(72) Inventors: Matthias Bühler, Hallstadt (DE); Thomas Weingärtner, Memmelsdorf (DE); Uwe Klippert, Rodental (DE); Uwe Sommer, Elfelder (DE); Anto Mijac, Bamberg (DE)

(21) Appl. No.: 14/394,457

(22) PCT Filed: Apr. 10, 2013
(86) PCT No.: PCT/EP2013/057462

§ 371 Date: Oct. 14, 2014

(30) Foreign Application Priority Data
Apr. 19, 2012 (DE) 10 2012 103 464.8

(51) Int. Cl. B60K 11/08

(52) U.S. Cl. CPC B60K 11/085
USPC 701/102

(57) ABSTRACT

An actuating drive for an air passage apparatus for engine cooling in a vehicle is provided. The actuating drive comprises a drive motor for adjusting the air passage apparatus and a control unit for controlling the drive motor, in which control unit are stored operating parameters for a first operating mode of the drive motor, in order to adjust the air passage apparatus between the open and closed position, as intended. The actuating drive has a drive element which is drivable by the drive motor and a driven element movable along an adjustment path with the drive element for adjusting the air passage apparatus. The drive element and the driven element are coupled together in an operating state for adjusting the air passage apparatus, and are decoupled from each other in another operating state, whereby the driven element is movable with respect to the drive element.

### CROSS-REFERENCE TO A RELATED APPLICATION

This application is a National Phase patent application of International Patent Application Number PCT/EP2013/057462, filed on Apr. 10, 2013, which claims priority of German Patent Application Number 10 2012 103 464.8, filed on Apr. 19, 2012.

### BACKGROUND

The present invention relates to an actuating drive of an air passage apparatus for cooling the engine of a vehicle and a method for controlling such an actuating drive.

Such an actuating drive is comprised of a drive motor for adjusting the air passage apparatus between an open position in which the air passage apparatus is maximally open for passage of an air stream and a closed position in which the air passage apparatus is closed in order to minimize an air stream. Such an air passage apparatus may be disposed, e.g., forwardly on the vehicle and control an air stream entering an engine compartment of the vehicle. For this, the air passage apparatus may be comprised of, e.g., closing elements in the nature of vanes, which can be adjusted in order to change the flow cross section for the air stream, and thereby to adjust an air stream for cooling an engine in the engine compartment.

In this connection, the drive motor, usually in the form of an electric motor, is controlled by an electronic control unit in which the operating parameters for a first operating mode of the drive motor are stored, parameters such as, e.g., the value and course of a motor current prevailing in the drive motor, or a rotational speed of the drive motor for an intended adjustment of the air passage apparatus between the open and the closed position. In particular, such an electronic control unit can achieve regulation of a drive shaft so that the shaft moves at a prescribed rotational speed, or so that the torque is constant, during an adjustment of the air passage apparatus.

In normal operation of the actuating drive and the air passage apparatus, the control unit controls, e.g., an adjusting position of the air passage apparatus, depending on control signals of a superordinate control device. The air passage apparatus is caused to be adjusted in particular depending on a temperature inside the engine compartment, wherewith control signals transmitted to the control unit are converted into an adjustment of the air passage apparatus in accordance with the operating parameters stored in the control unit.

Based on experience, during operation of the air passage apparatus various operating states and in particular malfunctions may occur which generally adversely affect the functional reliability and service life of the actuating drive and of the air passage apparatus altogether.

In DE 10 2011 007 523 is described an actuating drive for an air passage apparatus which accordingly provides a safety function (so-called “fail-safe” function) whereby, even in the event of failure of the power supply to the actuating drive, provisions are made such that the air passage apparatus does not permanently remain in the (completely) closed position. In this way, even in the event of failure of the power supply to the actuating drive, a cooling air stream into the interior of the engine compartment can be maintained.

With the actuating drive described in DE 10 2011 007 523, a mechanical safety function is provided which allows a drive element directly driven by the drive motor to be decoupled from a driven element, which drive element and driven element interact for an intended adjustment of the air passage apparatus. In this connection, it may occur that such a decoupling of the driven element and drive element occurs when not desired, wherewith the “fail-safe” mechanism which is provided is unintentionally triggered. This may occur, e.g., by external influences, e.g. by vibrations during an operation or voltage dips in the case of cold starting.

However, if a decoupling of the driven element from the drive element remains undetected, the air passage apparatus will remain in an at least partially open position. There is no automatic re-coupling of the driven element to the drive element, thus re-coupling of the adjusting mechanism of the actuating drive, but it rather must be provided for in a specific manner, e.g. in the actuating drive according to DE 10 2011 007 523 this is accomplished by adjusting the air passage apparatus into the open (end) position.

### SUMMARY

It is therefore desirable to be able to recognize an operating state of an air passage apparatus wherein in certain circumstances the air passage apparatus is malfunctioning, and an adjustment of the air passage apparatus on the basis of the operating parameters stored in the control unit is not optimal.

It is also desirable to be able to in as simple a manner as possible adjust the adjustment movement of an air passage apparatus, driven by the drive motor of the actuating drive, to the given current operating conditions, which conditions may vary depending on the installation situation and as a result of allowable mechanical tolerances.

Accordingly it is an object of the present invention to devise an improved actuating drive for an air passage apparatus for cooling of a vehicle engine, which actuating drive eliminates or at least minimizes the above-described drawbacks.

An actuating drive according to an exemplary embodiment of the invention has a control unit which is designed and configured such that
at least one operating variable of the drive motor, e.g. the intensity of an electric current prevailing in the drive motor (motor current), the level of the supply voltage, or the rotational speed of a drive shaft driven by the drive motor, can be determined during an adjustment of the air passage apparatus, and an evaluation can be made of whether the air passage apparatus is in an operating state in which the driven element is decoupled from the drive element; and
if such an operating state is present, to operate the drive motor in at least one additional operating mode, for at least one subsequent adjustment of the air passage apparatus, wherein different operating parameters are provided for the control of the drive motor, said operating parameters being different from those in the first operating mode of the drive motor.

Basically it is regarded as particularly advantageous if the control unit is designed and configured such that, during an adjustment of the air passage apparatus by the drive motor, variations in the load can be determined with the aid of the rotational speed of the drive motor and/or the level of the motor current prevailing in the drive motor, and, by means of an evaluation function introduced to the control unit, these can be evaluated as indicating the presence of different operating states. When the presence of a given operating state is determined, the control unit provides to the drive motor, permanently or at least temporarily, new operating parameters which are adapted to the determined operating state.

The present invention thereby proceeds from the concept that it is possible to recognize an operating state of the air passage apparatus with the aid of an operating variable of the drive motor during an adjustment of the air passage apparatus which adjustment is underway, and that one does not necessarily need additional circuitry or sensors on the air passage apparatus for this purpose. The term operating variable of the drive motor in this context should be understood to mean a quantity which is (electronically) measurable and which is a measure of the adjusting force provided by the drive motor during an adjustment of the air passage apparatus, e.g. a motor current, a rotational speed, or an applied power supply voltage. Thus, the course of such a parameter determined during the operation of the drive motor can provide information about whether the driven element has become decoupled from the drive element. One can further determine, with the aid of the course of an operating variable or a group of operating variables, whether, e.g., the air passage apparatus or its actuating drive is malfunctioning, and one can optimize the adjustment of the air passage apparatus, particularly with regard to noise generation, wear, adjusting speed, and/or power consumption.

Here, the present invention proposes and provides that the control unit of the actuating drive, after determining a particular operating state, which can be characterized in that the determined operating variable is above or below a prescribed limit value, or in that the determined (timewise) course of the operating variable varies (excessively) from a prescribed nominal course, will switch into a different operating mode. In this different operating mode, the drive motor will operate with operating parameters which differ from those of the prior operating mode. E.g., operating parameters will be provided to the drive motor which cause the air passage apparatus to be adjusted in the opposite adjustment direction, which briefly stop the drive motor, and/or which provide for a different course of the adjusting speed of the air passage apparatus for a subsequent adjustment or a plurality of subsequent adjustments. Accordingly, operating parameters for the drive motor prescribed by the control unit are meant to be parameters by means of which the adjusting force and the adjusting speed of the drive motor are controlled during an adjustment of the air passage apparatus which is to be carried out, and which confer a defined course to them.

In this connection, it may be provided that in addition the control unit is designed and configured such that, after determination of a particular operating state, to permanently operate the drive motor with changed operating parameters for the adjustment of the air passage apparatus. If, during an adjustment of the air passage apparatus, it is determined that a particular operating state is present, with the aid of at least one determined operating variable, new operating parameters will be provided by the control unit, for subsequent adjustments of the air passage apparatus, so that the drive motor will be permanently operated in the changed operating mode. In this connection it is particularly understood that the control unit, with the aid of the at least one determined operating variable of the drive motor, e.g. the rotational speed or the motor current, after installation of the actuating drive will recognize the first achievement of the open and/or closed position of the air passage apparatus, respectively as a (non-critical) operating state, in which the air passage apparatus is not further adjustable, and will change the operating parameters of the drive motor such that
a speed of the drive motor in a last segment of a predetermined adjustment path will be continuously reduced, before the air passage apparatus reaches the open or closed position,
the acceleration with an adjustment of the air passage apparatus from the open or closed position will be reduced, and/or
the maximum speed of the adjustment of the air passage apparatus between the open and closed position will be increased.

Consequently, the control unit determines, with the aid of the at least one determined operating variable, according to which covered adjusting path an end position of the air passage apparatus is reached, in that the determined operating variable varies in a characteristic fashion, e.g. sharply rises or falls. Thus, the achievement of an end position of the air passage apparatus can usually be determined via a characteristic rise in the motor current or an abrupt dip in the rotational speed of the drive shaft of the drive motor. After the control unit has “learned” to recognize the end position or end positions of the air passage apparatus, the operating parameters of the drive motors are adapted to this, so that an adjusting movement of the air passage apparatus prior to reaching the given end position is reduced by the control unit.

Alternatively or in addition to this, a variant embodiment is provided for this, wherein the drive motor is operated at least temporarily with operating parameters which are different from those of the first operating mode. Thus, it may be provided that the control unit changes into another operating mode, in order to react to a determined malfunction, as a possible operating state of the air passage apparatus.

In this connection, a nominal course for the at least one operating variable may be stored in the control unit, and the control unit may be designed and configured so as to evaluate whether during an adjustment of the air passage apparatus there is a deviation from the nominal course of the operating variable which is stored in the control unit. If the determined values of the operating variable exceed or fall below an allowable tolerance value of the stored nominal value, this is evaluated as a malfunction of the air passage apparatus, and the control unit causes the air passage apparatus to carry out a corrective adjusting movement and/or switches at least into an operating mode in which the air passage apparatus prevents possibly damaging adjustment movements. E.g. if the control unit determines, by means of a characteristic deviation from a prescribed nominal course, that the air passage apparatus may be stuck or even blocked, the control unit will switch into an operating mode in which an adjustment in the adjustment direction, in which the sticking or blocking was detected, took place, in order to avoid mechanical damage of the air passage apparatus.

Accordingly, determination of an operating state by the control unit is understood to mean that the control unit recognizes that a change has occurred in the adjusting movement of the air passage apparatus, while it is adjusted by the drive motor. This presently includes not only the recognition of non-critical operating states, such as the attainment of an end position of the air passage apparatus, but also the recognition of critical operating states which occur e.g. in malfunction situations. In reaction to the recognition of a new or changed operating state of the air passage apparatus, according to the invention the control unit is able to operate the drive motor with different operating parameters, i.e. to operate the drive motor differently from a prior normal operation. This includes the permanent change of the operating parameters for normal operation, and thereby in particular the prescription of a changed adjustment speed for an adjustment between the two possible end positions of the air passage apparatus along an allowed adjustment path, as well as automatic triggering of at least one (subsequent) adjusting movement to remediate an operating state which has been detected and has been evaluated as critical.

Thus, e.g., the control unit may be designed and configured so as to switch from the determined operating state into a different operating mode wherein a drive torque output by the drive motor may be increased (for a limited period of time), by a prescribed amount. In this way, possible operating problems in the adjusting mechanism of the air passage apparatus may be overcome.

Further, in another operating mode an adjusting movement of the air passage apparatus may be stopped and an adjustment of the air passage apparatus by means of the drive motors may be blocked, at least partially, in particular despite the fact that the control unit is receiving control signals from a superordinate control device to adjust the air passage apparatus. In this way, e.g., it is possible to impede (repeated) opening or closing of the air passage apparatus by the control unit of the actuating drive, at least temporarily, in reaction to a measured internal temperature in the engine compartment, despite the fact that a superordinate control device directs that this be done, because in a previous adjustment movement, a malfunction of the air passage apparatus has been recognized, and a new adjustment of the air passage apparatus under the circumstances would lead to permanent damage.

It may also be provided that, by means of a switching to another operating mode, an adjustment of the air passage apparatus in the direction of the open or closed position is stopped, and by means of the drive motor the air passage apparatus is automatically adjusted in the opposite adjustment direction. By such a reversal of the adjustment, after determination of a critical operating state, wherewith it is determined that there is an impediment in the adjustment path of the air passage apparatus (in particular in the adjustment path of its closing elements), with the aid of the measured course of the at least one evaluated operating variable, mechanical damage is avoided.

It may also be provided that, in another operating mode, the air passage apparatus is automatically adjusted to the open position by the drive motor, in which position the air passage apparatus is maximally open. This can bring about, e.g., a new coupling between a drive element and a driven element of the actuating drive, with an actuating drive such as disclosed in DE 10 2011 007 523, following an (un-desired) decoupling of the two elements, thus after a “fail-safe” mechanism of the actuating drive has been triggered. Thus a determined operating variable of the drive motor, e.g. a rotational speed or a motor current prevailing in the drive motor, indicates a course which deviates from the course under normal operation (in the first operating mode) during an adjustment of the air passage apparatus, when the drive element and the driven element are no longer coupled together. Since such a deviation from a stored nominal course always occurs in the same segment of an allowed adjustment path, it is already possible to make a reliable determination, with the aid of a single determined operating variable of the drive motor, as to whether an operating state is present wherein the drive element and the driven element of the actuating drive are not (or are no longer) coupled together.

According to a refinement of the present invention, the control unit is also coupled to a temperature sensor, and is designed and configured to determine whether a particular operating state is present, and/or to evaluate a temperature measured by the temperature sensor, for the control of a subsequent adjustment of the air passage apparatus.

The control unit can hereby in particular evaluate whether the temperature measured by the temperature sensor is above (or below) a prescribed limiting temperature value. This is useful, e.g., in order to be able to recognize whether a determined deviation of the at least one determined operating variable from a prescribed nominal course during an adjustment of the air passage apparatus has occurred for reasons related to the temperature. Thus, in particular, when the external temperature is below the freezing point and it is determined that an operating problem evaluated as a critical operating state is occurring during an adjustment of the air passage apparatus, it may be determined further that there is icing inside the actuating drive or on closing elements of the air passage apparatus. Then, further adjustment of the air passage apparatus by the control unit may be permitted, e.g., only if it is determined that the measured temperature is above the freezing point or above a prescribed lower limit of temperature, possibly for a prescribed period of time, so that an omission of the icing can be presumed. In this process, in order to conclude that there is possible icing, a measured temperature during the adjustment of the air passage apparatus is evaluated along with at least one operating variable of the actuating drive, e.g. the motor current, the rotational speed, or the power supply voltage.

From this angle, one may also conceive of an actuating drive for an air passage apparatus for cooling the engine of a vehicle which basically functions without the determination of an operating state, when a drive element is decoupled from a driven element of the actuating drive.

Such an actuating drive would thus have the following:
a drive motor for adjusting the air passage apparatus between an open position in which the air passage apparatus is maximally open for passage of an air stream and a closed position in which the air passage apparatus is closed so as to minimize an air stream; and
a control unit for controlling the drive motor, which control unit stores operating parameters for a first operating mode of the drive motor, in order to adjust the air passage apparatus between the open and closed position, as intended;

wherein the control unit is designed and configured such that
at least one operating variable of the drive motor can be determined during an adjustment of the air passage apparatus, and an evaluation can be made of whether the air passage apparatus is in a particular operating state, and
if such a particular operating state is present, to operate the drive motor in at least one additional operating mode, for at least one subsequent adjustment of the air passage apparatus, wherein different operating parameters are provided for control of the drive motor, said operating parameters being different from those in the first operating mode,

wherein further
a nominal course for the at least one operating variable in an adjustment of the air passage apparatus in the first operating mode is stored in the control unit, and the control unit is designed and configured to evaluate whether there is a deviation from the stored nominal course for the operating variable, and
the control unit is coupled to a temperature sensor, and additionally is designed and configured to determine whether a particular operating state is present, and additionally to evaluate a temperature measured by the temperature sensor, in order to recognize whether a determined deviation of the at least one determined operating variable from a prescribed nominal course during an adjustment of the air passage apparatus is caused by the temperature.

According to a variant embodiment, it is considered advantageous for the control unit to be designed and configured to recognize whether:
in an adjustment of the air passage apparatus in the direction of the closed position and prior to reaching an end position, an elevated load occurs which indicates an impediment or a mechanical problem in the air passage apparatus,
a load increases prior to reaching one of the two end positions, and an (external) temperature lies below the freezing point, in order to conclude an icing problem,
an abrupt blocking of the air passage apparatus has occurred, e.g. determinable by a rapid dip in the rotational speed, which cannot be compensated for, in order to conclude that an end position has been reached,
a load is unexpectedly permanently low, in order to conclude possible mechanical problems, e.g. a defective transmission or breakage inside the actuating drive,
a load increases in a characteristic fashion during slow adjustment of the air passage apparatus in the direction of the open position, and then steeply decreases again, in order to determine that there has been a triggering (an un-desired triggering) of a safety mechanism (“fail-safe” mechanism),
load variations occurring during an adjustment of the air passage apparatus are within prescribed tolerances, in order to classify these as wind loads or as normal load variations due to prescribed mechanical tolerances.

In addition to an actuating drive of an air passage apparatus for cooling the engine of a vehicle, a method for the electronic control of a drive motor of such an actuating drive is also an object of the invention.

Accordingly, an inventive method is distinguished in that
at least one operating variable of the drive motor, e.g. a rotational speed and/or the strength of the current prevailing in the drive motor (motor current), is determined during an adjustment of the air passage apparatus in a first operating mode, and an evaluation is made of whether an operating state of the air passage apparatus is present in which the driven element is decoupled from the drive element, and
when such an operating state is present, the drive motor is operated in at least one additional operating mode, for at least one subsequent adjustment of the air passage apparatus, in which operating parameters different from those to the first operating mode are provided, for control of the drive motor.

The previously described and hereinafter explained advantageous variant embodiments and characteristics of the actuating drive apply analogously to an inventive control method, and vice versa.

### BRIEF DESCRIPTION OF THE DRAWINGS

Additional advantages and characteristics of the invention will be apparent from the following.

FIG. 1 shows a schematic view of a vehicle with an air passage apparatus disposed forwardly thereon.

FIGS. 2A-2D show views of an actuating drive of an air passage apparatus in different operating states and different adjusting positions of the air passage apparatus.

FIG. 3A shows nominal courses of various operating variables of a drive motor of the actuating drive, over time, during an adjustment of the air passage apparatus between an open and a closed position.

FIG. 3B shows the actual course of the operating variables according to FIG. 3A, under circumstances of detectable deviations from the nominal courses during an adjustment of the air passage apparatus into the open position and in the presence of an operating state which is regarded as critical.

FIG. 4A shows alternative nominal courses of various operating variables of the drive motor when adjusting an air passage apparatus between an open and a closed position.

FIG. 4B shows the actual course of the operating variables according to FIG. 4A, under circumstances of detectable deviations from the nominal course during an adjustment of the air passage apparatus from the closed position to the open position, and the presence of an operating state which is regarded as critical.

FIG. 4C shows the actual course of the operating variables according to FIG. 4A, under circumstances of other detectable deviations during an adjustment of the air passage apparatus from the closed position to the open position, and the presence of a further operating state which is regarded as critical.

FIG. 5 courses of different operating variables of the drive motor during successive adjustments of an air passage apparatus, in different operating modes of the drive motor as predetermined by an electronic control unit.

### DETAILED DESCRIPTION

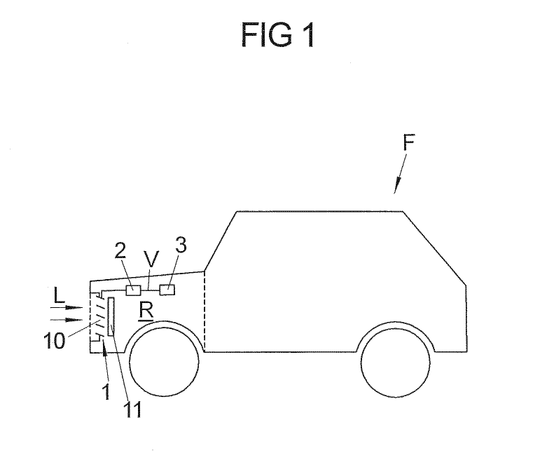

FIG. 1 is a schematic representation of a vehicle F, showing an air passage apparatus 1 disposed in an engine compartment R in the front region of the vehicle F.

The air passage apparatus 1, disposed at the front end face of the vehicle F in the region of a radiator grille, serves to control an air stream L into the engine compartment R for cooling an engine disposed in the engine compartment R. For this purpose, the air passage apparatus 1 has a plurality of adjustable vanes 10 which, when in an open position of the air passage apparatus 1, provide a large flow cross section for the air flow L into the engine compartment R of the vehicle F, and can be adjusted to reduce the flow cross section.

In a position downstream of the vanes 10 in the direction of flow, a fan 11 is disposed for the intake of the air stream L.

The vanes 10 are acted upon by an actuating drive 2, which is connected to a power supply system 3 of the vehicle F. The electromotive actuating drive 2 serves to adjust the vanes 10 to alter the flow cross section of the air passage apparatus 1, and is supplied with electricity via the power supply system of the vehicle, which delivers a voltage V for this purpose, by means of which voltage the electrical drive means of the actuating drive can be driven.

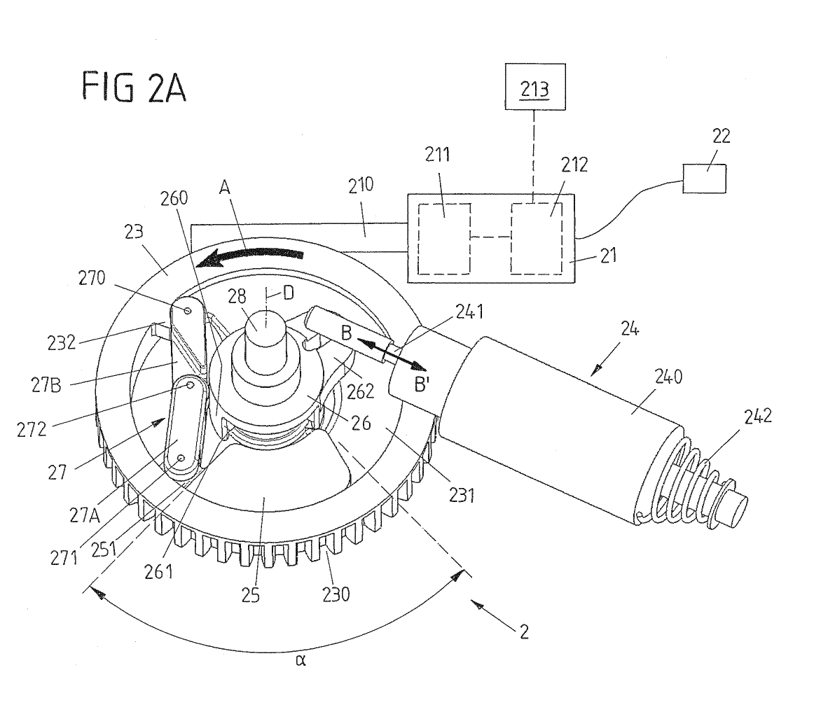

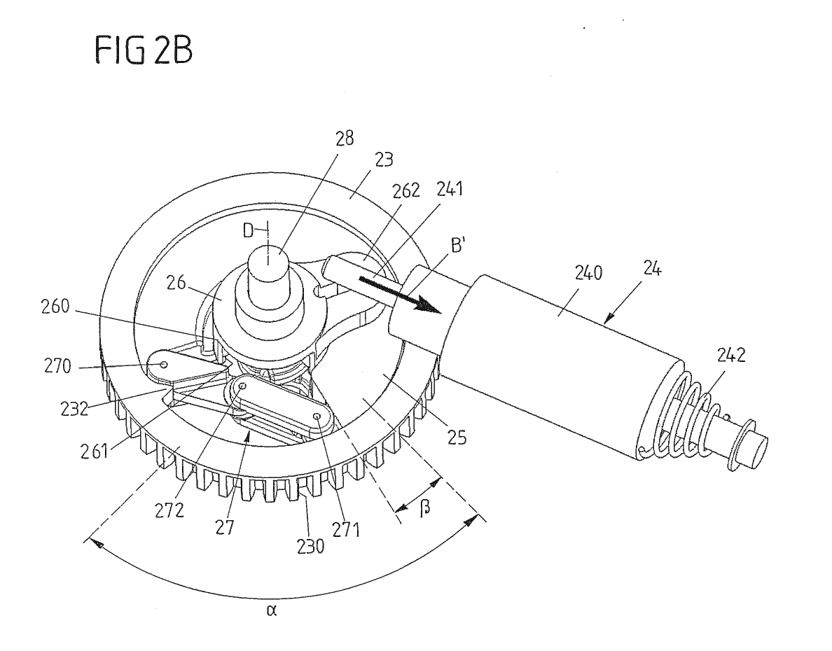

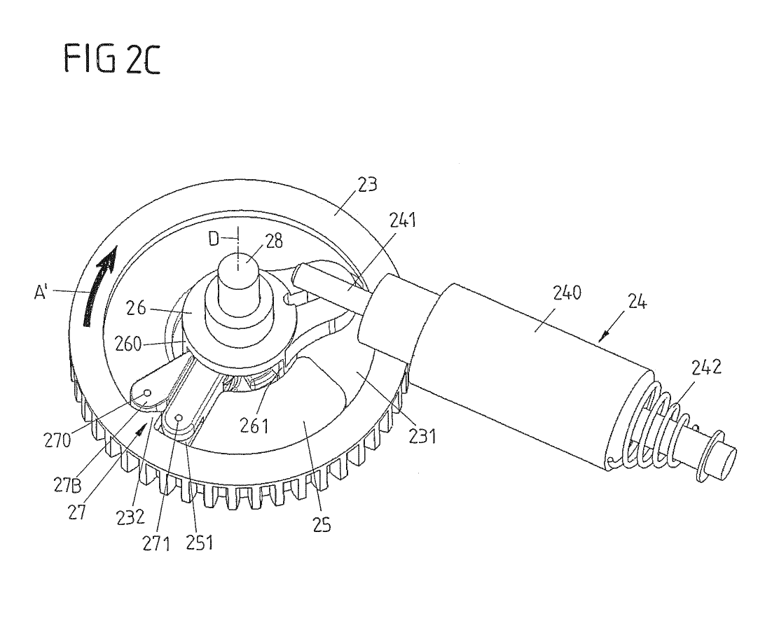

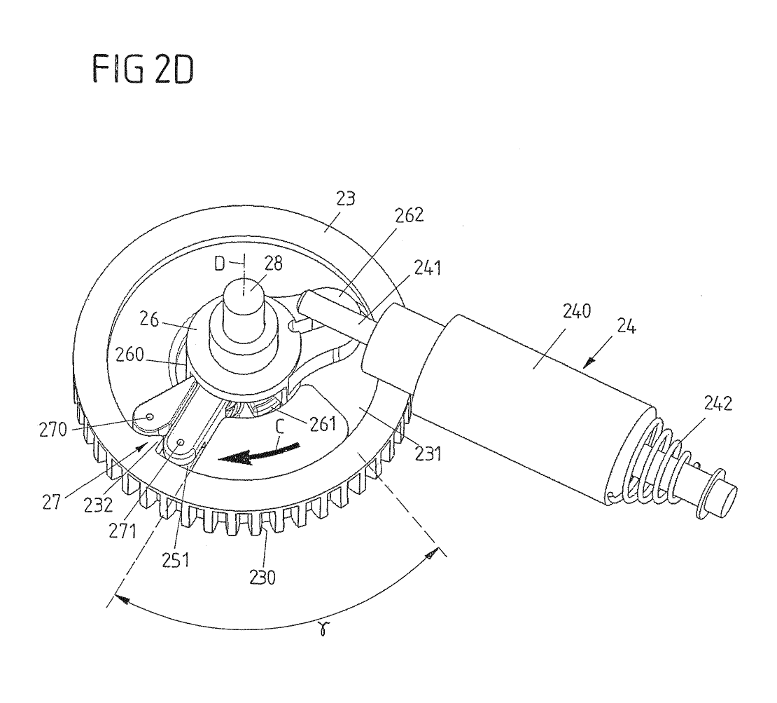

In FIGS. 2A to 2D, an exemplary embodiment of such an actuating drive 2 is illustrated in various views and operating states. The basic structure of an actuating drive according to FIGS. 2A to 2D, and the manner of its functioning, are disclosed, e.g., in DE 10 201 1 007 523.

As shown schematically in FIG. 2A, the actuating drive 2 has an electric motor drive 21 which is connected to the power supply system 3 (see FIG. 1) of the vehicle F via a plug 22. The drive means 21 has a drive motor 211 in the form of an electric motor, an electronic control unit 212, and a rotary drive shaft 210 which intermeshingly engages with a drive element in the form of a drive wheel 23 which is rotatable on a shaft 28 around an axis of rotation D. For this purpose, the drive shaft 210 bears a drive screw which engages the external gear teeth 230 of the drive wheel, which drive wheel is in the form of a spur gear.

The actuating drive 2 has a driven element 25 which is displaceably mounted in the circumferential direction on the drive wheel, around the axis of rotation D, for which purpose element 25 is disposed on a slide surface 231 of the drive wheel 23.

The driven element 25 is coupled to the drive wheel 23 via a transmission element 27 in the form of an articulated lever. The transmission element 27 is formed by two levers 27A and 27B, one of which, 27B is coupled to the drive wheel via a pivot point 270 in an articulated manner, and the other 27A is coupled to fixing point 251 of the driven element 25 via a pivot point 271 in an articulated manner. The levers 27A and 27B are further mutually connected in an articulated manner, via a pivot point 272, resulting in an articulated lever which allows relative movement between the drive wheel 23 and the driven element 25, with the levers 27A and 27B being able to pivot relative to each other.

The driven element 25 is coupled to vanes 10 of the air passage apparatus 1, and adjusts these vanes between an open position in which the air stream L can pass through the air passage apparatus 1 and a closed position in which the air stream is maximally suppressed (see FIG. 1). For this purpose, the driven element 25 can be driven by the drive wheel 23 along an adjustment path α in an angular range of ca. 90°, whereby the driven element 25 transmits an adjusting force and an adjusting excursion to the vanes 10 of the air passage apparatus 1, with an adjusting angle of 0° (see FIG. 2A) corresponding to a maximally opened position of the air passage apparatus 1 and an adjusting angle of ca. 90° corresponding to a maximally closed position of the air passage apparatus 1.

An adjusting element 26 is disposed on the shaft 28 of the drive wheel 23, which element 26 can be pivoted around the axis of rotation D relative to the drive wheel 23 and to the driven element 25. The adjusting element 26 has a circular cylindrical basic shape with a cylindrical encircling surface 260 that is interrupted in the circumferential direction in sections by a recess 261. The adjusting element 26 is engaged via a lever element 261 by an actuating rod 241 of an actuator 24 which serves to adjust the adjusting element 26, having for this purpose an electrically operated solenoid 240 which acts upon the actuating rod 241. The actuating rod 241 is pre-stressed by a spring 242 in the direction of a retracted position corresponding to the position of the actuating rod 241 shown in FIG. 2A.

The actuator 22|[M|ML1], in interaction with the adjusting element 26, serves to control the transmission element 27 and thereby to adjust the coupling between the drive wheel 23 and the driven element 25. In particular, the adjusting element 26, with its cylindrical surface 260 and the recess 261 in said surface, is configured to support force transmission between the drive wheel 23 and the driven element 25, as illustrated in FIG. 2A, depending on the position of the adjusting element 26 and depending on the position of the driven element 25 along its adjustment path α, and further is configured to enable a relative movement between the driven element 25 and the drive wheel in order to provide a securing function (“fail-safe” function), as will be described in more detail below with reference to FIGS. 2C and 2D.

In normal operation, in which the drive motor 211 is operated in a (first) operating mode via the control unit 212, on the basis of operating parameters stored in the control unit 212, the drive wheel 23 is displaced via the drive device 21, and along with it the driven element 25 for displacing the air passage apparatus 1 is displaced along a rotational direction A and along the adjustment path α.

If initially, starting from the position according to FIG. 2A, the drive wheel 23 is moved in the rotational direction A, the adjusting force introduced to the drive wheel 23 is transmitted to the driven element 25 via the transmission element 27 and the driven element is moved along with the drive wheel, in rigid fashion. For this purpose, the articulation 272 of the transmission element 27 is supported against the cylindrical surface 260 of the adjusting element 26, so that it is impossible for the transmission element 27 in the form of an articulated lever to buckle, and thereby the driven element 25 is directly coupled to the drive wheel 23 via the transmission element 27. Since the lever 27B of the transmission element is additionally fixed against buckling in a direction away from the adjusting element 26, by means of a wedge-shaped inwardly projecting projection 232 on the drive wheel 23, the transmission element 27 is blocked, so that the levers 27A and 27B cannot move relative to each other, and they provide a rigid connection of the drive wheel 23 with the driven element 25.

As illustrated in FIG. 2A, the actuator 24 is initially not supplied with power, in executing an adjusting movement starting from a maximally open position of the air passage apparatus 1, the purpose of this non-powering being to save the energy that would otherwise be consumed. In normal operation, power is not supplied to the actuator 24 as long as the driven element 25 is disposed in a range of the adjustment path α in which the transmission element 27 with its articulation 272 is supported against the cylindrical surface 260 of the adjusting element 26.

If the drive wheel 23 is moved in the direction of rotation A, the driven element 25 is moved along with it. Because the articulation 272 approaches the recess 261 in the cylindrical surface 260 of the adjusting element 26, power is supplied to the actuator 24, and the actuating rod 241 is moved in the direction B, whereby the adjusting element 26 is moved into a position in which the articulation 272 of the transmission element 27 is supported against the surface 260 of the adjusting element 260 along the entire adjustment path α.

Due to its support against the adjusting element 26, the driven element 25 is directly coupled to the drive wheel 23 along the entire adjustment path α in normal operation, and is moved along with the drive wheel 23 along the direction of rotation A.

In order to move the air passage apparatus 1 back in an electromotive manner, the drive wheel 23, driven by the drive device 21, is moved back against the direction of rotation A, and the driven element 25 is correspondingly displaced backward along with the drive wheel 23. For this purpose, the drive motor 211 is operated and controlled once again via the control unit 212, on the basis of the operating parameters stored for the established (first) operating mode.

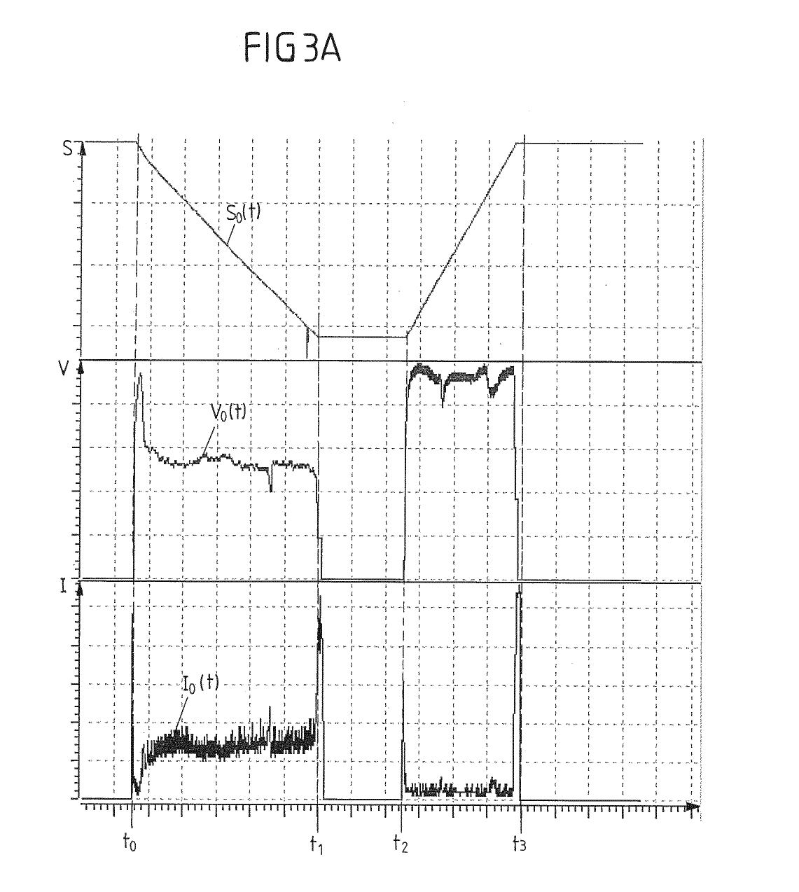

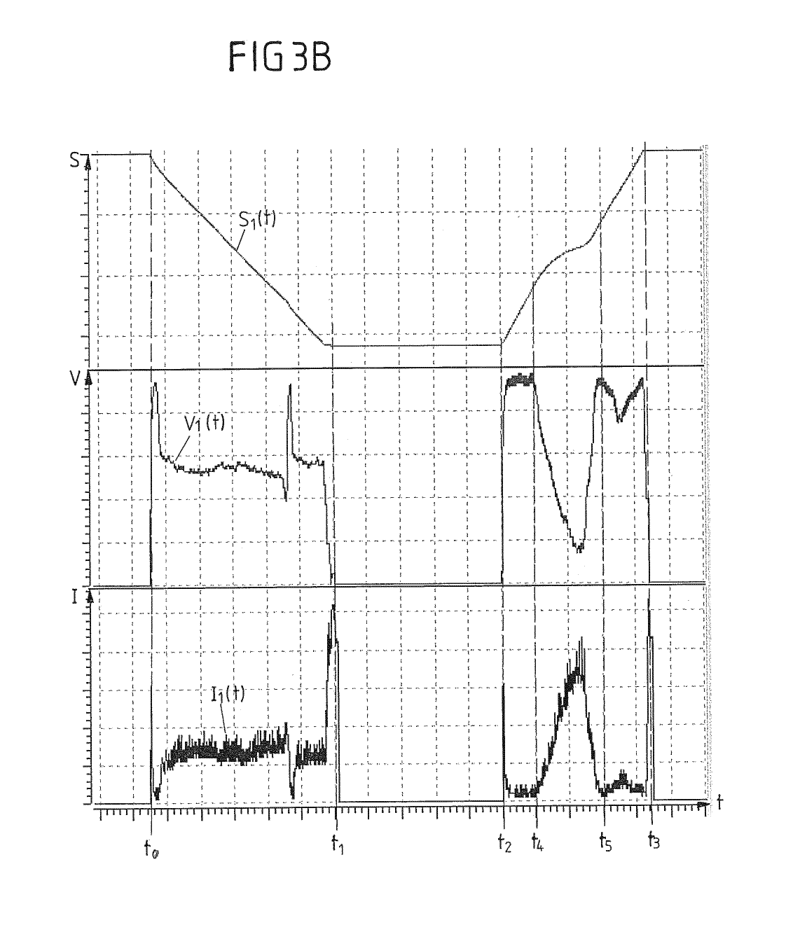

The actuator 24 displaces the adjusting element 26 basically in dependence on a voltage V which is supplied to the actuating drive 2 via the power supply system 3 of the vehicle F. If a sufficient voltage V is applied to the actuating drive 2, the actuator 24 will be powered (unless the driven element 25 is in a position which corresponds to the open air passage apparatus 1, see FIG. 2A). If the voltage applied to the actuating drive 2 is insufficient, the actuator 24 will not be powered, and the actuating rod 241 will be retracted in a direction B′, as shown in FIG. 3A. In this way, the actuator 24 provides a “fail-safe” function, whereby the driven element 25 is decoupled from the drive wheel 25 when insufficient electric power supply to the actuating drive 2 is detected, e.g. due to the voltage V falling below a prescribed threshold value, such that opening of the air passage apparatus 1 is necessary because the air passage apparatus 1 with its vanes 10 is currently in a closed or nearly closed position. Under these circumstances, relative movement of the driven element relative to the drive wheel 23 should be enabled, in order to automatically return the vanes 10 into the open position, e.g. under the action of a suitable spring pre-stressing, in order to ensure provision of an air stream L for cooling of an engine in the engine compartment R (FIG. 1) of the vehicle F, which engine needs to be cooled, particularly in an instance of failure of electric powering of the actuating drive 2. Thus the actuating drive 2 is in an operating state in which the drive wheel 23 is not (is no longer) coupled to the driven element 25.

Decoupling of the driven element 25 from the drive wheel 23 is necessary because the actuating drive 2 in the case of a closed force transmission path between the drive device 21 and the driven element 25 can be self-restraining, so that a retraction without actuation of the drive device 21 would be impossible or very difficult. Such a self-restraining may be caused, e.g. by the engagement of the drive shaft 210 in the drive wheel 23, or by an additional drive disposed between the drive device 210 and the drive wheel 23.

If the voltage V supplied by the power supply system 3 is not applied, e.g. because the power supply system is completely non-functional or the electrical connection between the power supply system 3 and the actuating drive 2 is interfered with, no power is applied (any longer) to the electrical solenoid 240 of the actuator 24, and the actuating rod 241 is displaced into a retracted position, as a result of the pre-stressed spring 242. Together with the actuating rod 241, the adjusting element 26 coupled to the actuating rod 241 via the lever element 262 is also pivoted.

If the driven element 25 is as shown in FIG. 3A, in the case of failure of the electrical supply and thereby an accompanying drop in the voltage in a segment β of the adjustment path α (FIG. 2B), corresponding to a closed or nearly closed position of the air passage apparatus 1, the articulation 272 of the transmission element 27 becomes disposed in the region of the recess 261 on the cylindrical surface 260 of the adjusting element 26, when the adjusting element 26 is displaced by retraction of the actuating rod 241. The articulation 272 now no longer rests against the cylindrical surface 260 of the adjusting element 26, and is no longer radially supported by the adjusting element 26.

Rather, as illustrated in FIGS. 2C and 2D, the transmission element 27 with its articulation 272 can penetrate into the recess 261 of the adjusting element 26, so that the driven element 25 can move in the direction C relative to the drive wheel 23, and thus the driven element 25 can be moved while the drive wheel 23 is fixed. In this way, the driven element 25 can be moved in the direction C in order to convert the air passage apparatus 1 into an open position and thereby to allow an air stream L to pass through the air passage apparatus 1.

As seen from FIG. 2C, the driven element 25 is movable through a maximum backward path γ with respect to the drive wheel 23, which is smaller than the adjustment path α in normal operation of the actuating drive 2. By the relative movement between the driven element 25 and the drive wheel 23, thus the air passage apparatus 1 can be converted to an at least substantially open position, with the vanes 10 maximally opened.

FIG. 3A illustrates nominal courses of two determined operating variables of the drive motor during an adjustment of the air passage apparatus 1 from an open position to a closed position, and during a subsequent adjustment from the closed position to the open position. The operating variables, determined and evaluated by the control unit 212, are here the rotational speed v of the drive shaft and the motor current l in the drive motor 211, over the time t. Additionally, in a path versus time diagram an adjusting path s of the drive shaft 210 is plotted over time t. Hereby, a descending line represents rotation of the drive shaft 210 into an adjustment position in which the air passage apparatus 1 is closed, while an ascending line represents opening of the air passage apparatus 1.

In normal operation, the control unit controls the drive motor 211 in a first operating mode, so that the nominal courses s0(t), v0(t), and l0(t) result as illustrated in FIG. 3A, for adjustment of the air passage apparatus between the closed and the open position—possibly with certain deviations due to allowable mechanical tolerances and wear. The time points t0, ti, t2, and t3 plotted in the diagrams of FIG. 3A are time points at which the air passage apparatus 1 reaches a respective end position. Thus, at time points t0 and t3, the air passage apparatus 1 is in the open position, in which the air passage apparatus is maximally open. At time points ti and t2, the air passage apparatus 1 is in the closed position.

In normal operation of the actuating drive 2, the operating variables determined by the control unit 212, here rotational speed v and/or the motor current l, are within a prescribed tolerance range, along the respective nominal course v0 and l0 stored in the control unit 212, for the determined operating variable.

The present invention now proceeds from the concept that with evaluation of such determined operating variables—possibly without additional sensors on the air passage apparatus 1 or in the associated actuating drive 2—one can determine whether the air passage apparatus 1 is in an operating state which makes a change in the operation of the actuating drive 2 necessary.

With an actuating drive 2, by external influences, such as vibrations, voltage dips, or possible mechanical defects, the drive wheel 23 may become decoupled from the driven element 25, thus the “fail-safe” mechanism may be triggered, and this may not be recognized because of a lack of sensors within the actuating drive 2. In this connection, the levers 27A and 27B of the transmission element 27 can partly penetrate into the recess 261 of the surface 260 of the adjusting element 26 (FIGS. 2C and 2D), so that the driven element 25 is movable relative to the drive wheel 23, and a displacement of the drive wheel 23 by the drive motor 211 in the direction of rotation A under some circumstances does not lead directly to rotation of the driven element 25.

FIG. 3B shows, in an exemplary manner, measured actual courses v1 and for the rotational speed v and motor current l when the air passage apparatus 1 is adjusted from the open position to the closed position, and back, when an (undesired) triggering of the fail-safe function of the actuating drive 2 is determined. In the course of adjustment from the closed position into the open position (time interval t2 to t3), there is a deviation from the nominal courses shown in FIG. 3A, starting from an error-free operation of the air passage apparatus 1. Thus, in the course of the reverse adjusting path, there is a brief dip in the rotational speed v followed by a rise in the rotational speed v, and an associated rise and subsequent fall of the motor current l. These appreciable deviations from the expected nominal courses in normal operation, v0 and l0, occur primarily in a time interval t4 to t5, and along a particular segment along the allowable adjustment path of the air passage apparatus 1 and the allowable adjustment path α of the driven element 25.

Presently, the control unit 212 is designed and provided to recognize such a deviation as illustrated in the actual courses Vi and FIG. 3B, and to evaluate it in that fail-safe function of the actuating drive 2 was actuated, and accordingly the drive wheel 23 is not (is not any longer) coupled to the driven element 25. This is evaluated as a critical operating state, because it may be associated with disturbances of the functioning of the air passage apparatus 1.

If, in the course of adjusting the air passage apparatus 1 via the motor current l and/or the rotational speed v, a deviation from a nominal course stored in the control unit 212 according to FIG. 3B is determined, the control unit 212 can thereby determine that an operating state is present in which the drive wheel 23 and the driven element 25 are not coupled directly to each other as intended, and that the fail-safe function of the actuating drive 2 has been triggered. Due to the configuration of the actuating drive 2 with the drive wheel 23, the driven element 25, and the transmission element 27 rigidly coupling the two elements, a detectable characteristic deviation in the rotational speed v and the motor current l always occurs at the same location along a permissible adjustment path, i.e. always in the same region between the closed and the open position of the air passage apparatus 1. Consequently, the control unit 212, when the system passes through a certain segment of the permitted adjustment path of the air passage apparatus 1, can recognize whether the system is in an operating state which is deemed critical, with the aid of the determined rotational speed v or the determined motor current l.

If the control unit 212 determines that the fail-safe function of the actuating drive 2 has been triggered, the control unit 212 switches into another operating mode, to cause the actuating drive 2 to automatically and possibly independently from or even in conflict with the control signals of a superordinate control device for the motor cooling cause an adjusting movement in order to cure the determined malfunction.

Thus the control unit 212 causes the drive motor 211 of the drive device 21 to engage in a reactive operation, resulting in a (new) direct coupling of the drive wheel 23 with the driven element 25 via the transmission element 27. For this, the air passage apparatus 1 is shifted into the open position in which the apparatus is maximally open to passage of the air stream. Consequently, the two levers 27A and 27B are moved out of the recess 261 of the adjusting element 26 (FIG. 2D), so that once again a support of the transmission element 27 in the region of its articulation 272 can be brought about by the adjusting element 26, and once again an adjusting force on the drive wheel 23 can be transmitted directly to the driven element 25 via the transmission element 27. After conclusion of the relative movement, i.e. after re-coupling of the drive wheel 23 with the driven element 25, the control unit 212 returns to normal operation (first operating mode).

In this way, an unnoticed malfunction, resulting from an undesired triggering of a “fail-safe” mechanism of the actuating drive 2, can be recognized, particularly without additional switches or sensors, but exclusively with the aid of at least one determined operating parameter of the drive motor 211, e.g. the rotational speed v or the motor current l. By means of an intermittent, that is, time-limited switching into another operating mode, it is also possible to remove the determined malfunction.

Furthermore, in the event of a repeated determination of the same malfunction by the control unit 212, a permanent defect may be concluded, and this may be reported to, e.g., a superordinate control device by emitting an error signal.

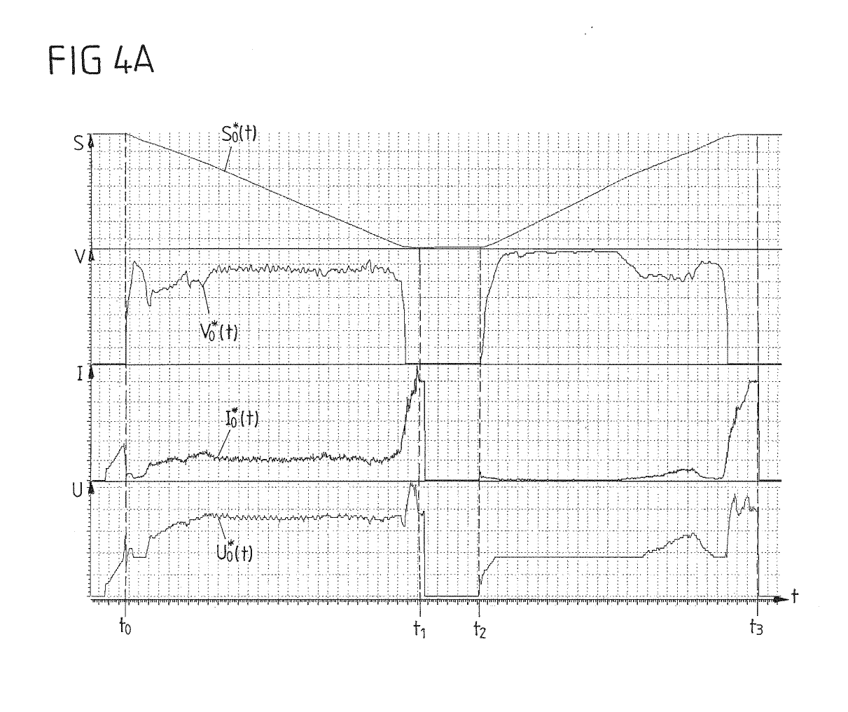

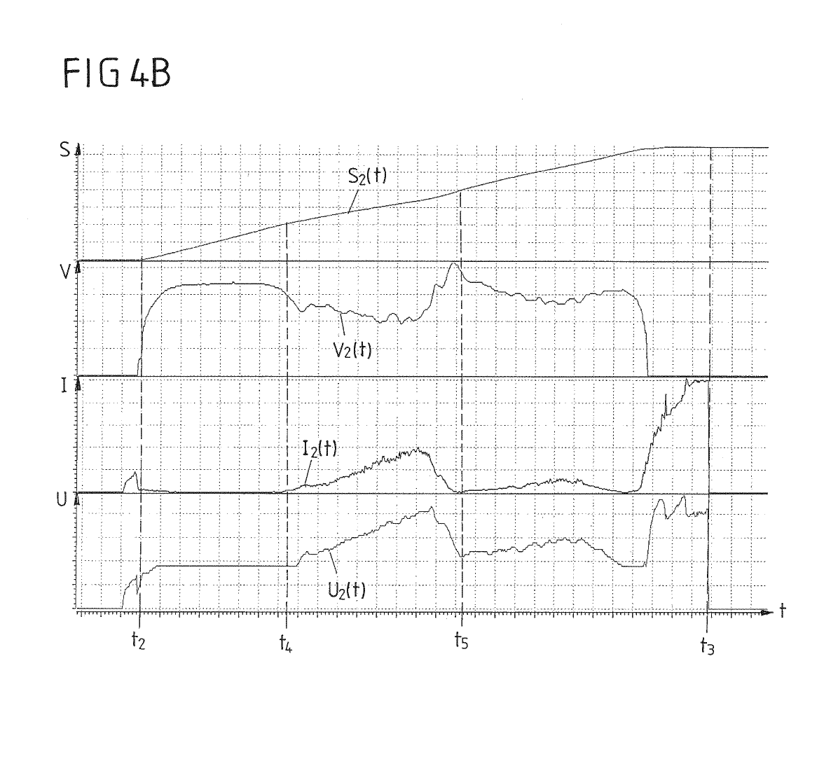

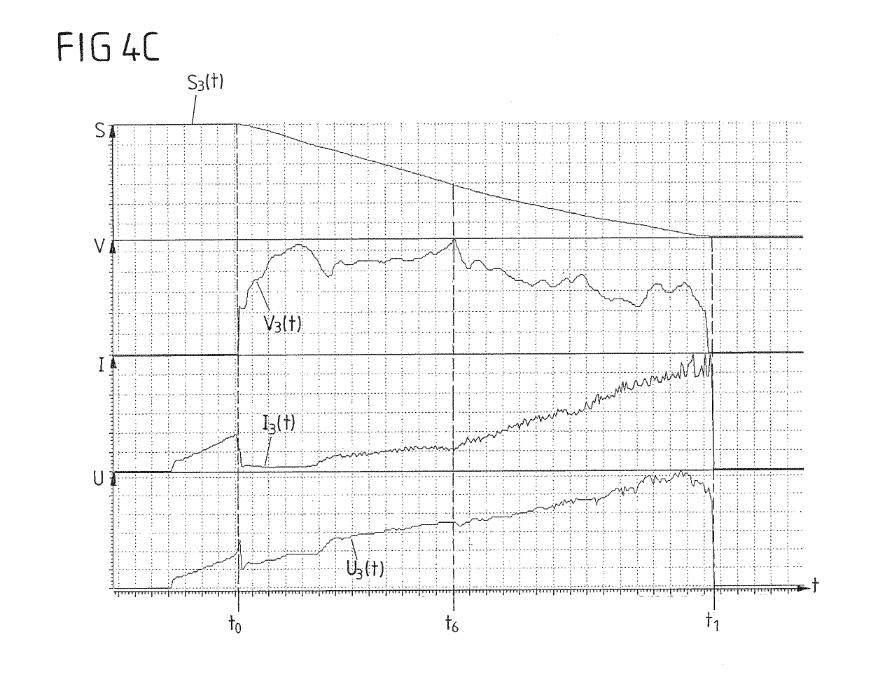

Based on a determined operating variable or a plurality of determined operating variables of the drive motor 211, other operating states of the air passage apparatus 1 can be reliably recognized. This is illustrated in FIG. 4A to 4C.

FIG. 4A newly shows nominal courses v0*, l0*, and U0* for the rotational speed v, the motor current l, and a supply voltage U of the drive motor 211 in an exemplary manner when adjusting the air passage apparatus 1 between the open and closed position. Here at times t0 and t3 the air passage apparatus 1 is in the open position, and at times ti and t2 the air passage apparatus 1 is in the closed position. The slight deviation of the course of the operating variables illustrated here compared to those of FIG. 3A is attributable to, e.g., inherent mechanical tolerances relating to the air passage apparatus 1 in connection with the adjusting drive 2.

FIG. 4B illustrates actual courses v2, l2, and U2, analogous to the curves of FIG. 3B, indicating the triggered fail-safe function of the actuating drive 2 when the air passage apparatus 1 is adjusted in the direction of the open position in normal operation, as intended. Here as well one can see the characteristic deviations in the curves of the operating variables v, l, and U shown in FIG. 3B, when the drive wheel 23 is not rigidly coupled to the driven wheel 25. This can be evaluated by the electronic control unit 212, which takes it as an occasion to change to an operating mode in which the drive motor is controlled in a different manner than in normal operation, in order to carry out a reactive operation.

In FIG. 4C another operating state is illustrated, as an example, wherein the determined and evaluated operating variables v, l, and U of the drive motor 211 can be determined without additional sensors. The courses v3, l3, and U3 for the rotational speed v, the motor current l, and the supply voltage U of the drive motor 211 are plotted for the time t during which the air passage apparatus 1 is adjusted from the open to the closed position. It is seen that at time t6 the rotational speed v unexpectedly, i.e. outside of allowable tolerances, decreases in a deviation from the intended course v0 according to FIG. 4A, and the motor current l and the supply voltage U unexpectedly increase, until the air passage apparatus 1 is present in the closed position.

Such an actual course of an operating parameter (v, l, U) may indicate an impediment in the adjustment path of the air passage apparatus 1, particularly in the region of its closing elements. If the electronic control unit 212 detects such a deviation from the nominal course v0, l0, or U0, the control unit 212 evaluates this as a (further) “critical” operating state, in which a (different) malfunction of the air passage apparatus 1 or its actuating drive 2 is occurring. As a result, the control unit 212 is designed such that in the face of an unexpected and continuing decrease of the rotational speed v of the drive shaft 210 or an unexpected and continuing increase of the motor current l prior to the air passage apparatus 1 reaching its end position during an adjustment of the air passage apparatus 1 in the direction of the closed position, the control unit will determine that there is an impediment in the adjusting path of the air passage apparatus. After determination of such a “critical” operating state, the system is converted temporarily into another operating mode, in which e.g. the air passage apparatus 1 is shifted into the opposite adjustment direction, which enables the risk of permanent mechanical damage to the air passage apparatus 1 to be minimized or prevented. Here as a result the drive motor 211 and/or an adjusting movement by the drive motor 211 is automatically reversed, after the control unit 212 concludes that there is an impediment in the adjusting path, based on the unexpected increase in the motor current l or the unexpected decrease in the rotational speed v.

Consequently, the electronic control unit 212 of the actuating drive 2 may be designed and provided to determine a plurality of different operating states based on an operating parameter of the drive motor 211, e.g. the motor current l or the rotational speed v, and after the operating state is determined the control unit 212 may convert the system to a different operating mode among a number of possible operating modes, in order to trigger an adjustment movement appropriate for the given operating state, or to prevent certain adjusting movements.

When the control unit 212 undertakes to evaluate whether a particular (critical) operating state is in effect, it may also take into account temperature measurements from a temperature sensor 213 (FIG. 2A). For example, if the temperature sensor 213 indicates (external) temperatures below freezing, and at the same time in connection with a closing movement of the air passage apparatus 1 it is determined that the motor current l has increased or the rotational speed v has decreased prior to reaching the closed position, this may indicate possible icing. The control unit 212 will then evaluate this as a (third) operating state of the air passage apparatus 1, wherewith the drive motor 211 must be controlled with different operating parameters.

Thus, e.g., in this connection it may be provided that adjustments of the air passage apparatus (in the direction of the closed and/or open position) may be prevented for a defined time interval; thus, despite corresponding control signals from a superordinate control device, adjustment of the air passage apparatus 1 by the drive motor 211 is prevented. The air passage apparatus will be free to be adjusted by the control unit only, e.g., if icing can definitely be excluded, e.g. if a temperature communicated from the temperature sensor 213 to the control unit 212 is above a lower limit temperature and particularly above the freezing point, preferably for a defined time.

Further, an electronic control unit 212 can be designed to shift into another operating mode for an extended period, with different operating parameters for the drive motor 211 being provided for the adjustment of the air passage apparatus 1. Thus, in particular the control unit 212 may be able to adaptively learn the operating parameters which will be provided for the adjustment of the air passage apparatus 1 in normal operation.

Here, a first operating mode can be provided for by the electronic control unit 211 for the first process of adjustment the air passage apparatus 1 into the closed and into the open position after the mounting of the actuating drive 2. In this operating mode, the control unit 212 will first prescribe a comparatively low adjustment speed of the drive shaft 210, but the electronic control unit 212 does not yet exactly contain the information as to what adjusting distance s of the drive shaft starting from the current adjustment position is needed to reach the given end position of the air passage apparatus 1. If the air passage apparatus 1 is moved into the end position through excessive adjusting speed, the air passage apparatus 1 may suffer damage, and in particularly the closing elements of the air passage apparatus 1 may suffer damage. If the end positions of the air passage apparatus 1 are determined to be non-critical operating states based on an operating parameter of the drive motor 211, then based on this, new, changed operating parameters may be prescribed through the evaluation functions of the control unit 212, for achieving the intended normal operation.

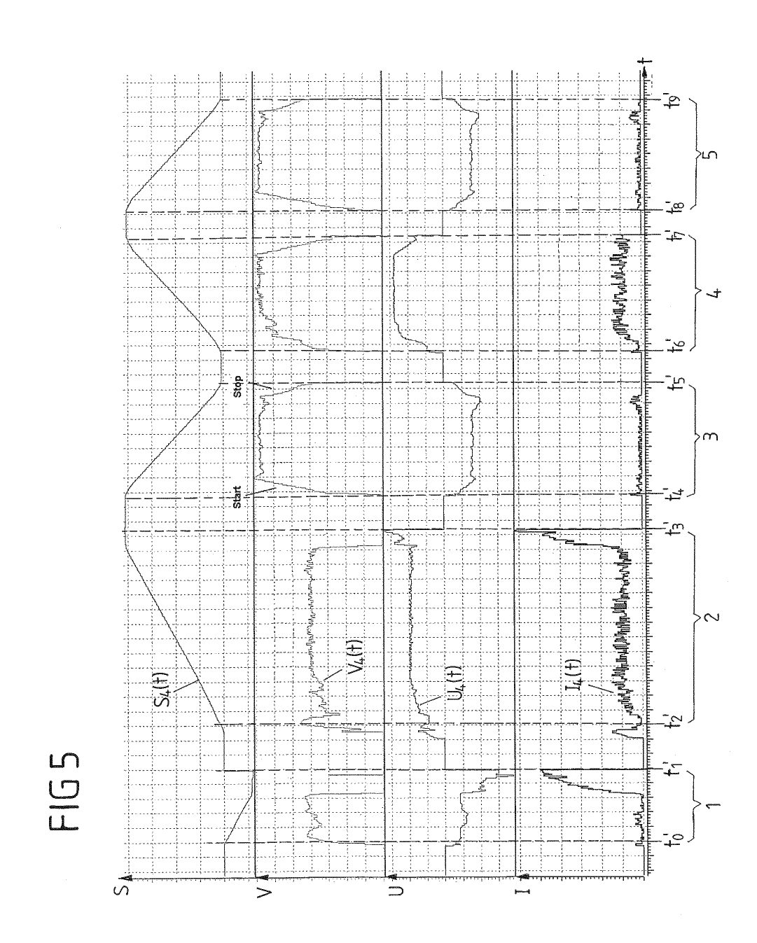

In FIG. 5, such a change of the operating parameters is indicated, from diagrams in which, once again, the rotational speed v, the supply voltage U, and the motor current l, and the adjusting path s of the drive shaft 210 are plotted versus time t. In this connection it should be noted that in the path distance versus time diagram of FIG. 5, in contrast to the diagrams of FIGS. 3A-3B and 4A-4C, an adjustment of the air passage apparatus 1 into the open position is indicated by a decreasing straight line, and an adjustment of the air passage apparatus 1 into the closed position is indicated by an increasing straight line.

In the case of an initial adjustment of the air passage apparatus 1 into the open position by the drive motor 211, here in the time interval t0′ to t1′ (interval “1”), the drive shaft 210 is initially operated at a relatively low speed. If an abrupt decrease in the rotational speed v or an abrupt increase in the motor current l occurs at a time t, the electronic control unit 212 determines that the air passage apparatus 1 has reached an end position, at which no further displacement in the same adjustment direction is possible. Based on this, the operating parameters for a subsequent shift into the open position are permanently changed, so that this shift is optimized, e.g. with respect to noise generation, friction, adjusting speed, and or power consumption of the actuating drive 2. This can be achieved, e.g., by adjustment of a prescribed nominal course of the rotational speed for the drive motor 21 for adjustment of the air passage apparatus. Thus, for starting and stopping of the adjusting movement, ramps of the rotational speed can be prescribed by the electronic control unit 212.

The operating parameters can be adjusted in the variant embodiment according to FIG. 5 also in relation to adjustment of the air passage apparatus 1 into the closed position, after the air passage apparatus 1 has first been shifted from the open position into the closed position in the time interval t2′ to t3′ (interval “2”).

By means of the changes of the operating parameters carried out by the control unit 212 after the two initial shifts of the air passage apparatus 1 into the open position and into the closed position, which define the operating mode of the drive motor 211 for the intended normal operation, the subsequent shifts of the air passage apparatus 1 are optimized, and are adjusted to the mechanical conditions of the particular air passage apparatus 1. Thus, the curves v4, U4, and l4 shown in FIG. 5, in the intervals “3”, “4”, and “5”, have an intended course as shown for the subsequent shift of the air passage apparatus 1 from the open to the closed position (time interval t4′ to t5′), from the open to the closed position (time interval t6′ to t7′), and then from the closed to the open position (time interval t8′ to t9′), wherein the intended course of the determined operating variables v, U, and l is different from that in intervals “1” and “2”. Thus, e.g., a shift will proceed basically at a high maximum rotational speed and a more controlled stoppage prior to reaching the given end position.

In the present variant embodiment of an inventive actuating drive, and of an associated inventive method of electronic control of an actuating drive for an air passage apparatus 1 for engine cooling of a vehicle F, there are always provided means of determining variations in the (mechanical) load applied to the drive motor 211, with the aid of at least one operating variable, such as the rotational speed v or the motor current l, and means of evaluating whether a permanent or temporary change in the operating parameters for controlling the drive motor is necessary. In this way, in particular one can achieve situation-dependent regulation of the rotational speed, wherein depending on the operating state the drive motor 211 will be caused to perform a particular action by the electronic control unit 212, such as, e.g., increasing the drive torque in order to overcome normal operating difficulties, or to stop or reverse the adjustment movement, or to relieve the stress on a drive, and thereby to achieve a certain adjustment movement of the air passage apparatus 1 in a manner which deviates from normal operation. In this way, depending on the determined operating state, the system may be switched to an operating mode in which “critical” actions or adjustments of the air passage apparatus 1, such as further operation at an elevated drive torque, or a continuous attempt to open or close the closure elements of the air passage apparatus 1 in the event of icing, can be advantageously prevented by the control unit 212.

In the process, variations in load which occur which characterize a “critical” operating state with a suspected malfunction are (preferably) distinguishable from load variations which occur e.g. by wind stresses and/or normal operating difficulties and mechanical tolerances. This is possible, e.g., by specifying corresponding tolerance ranges for a prescribed nominal course in which deviations are permissible without a determination of a new (“critical”) operating state. The values of the tolerance ranges input to the control unit may obviously also vary depending on a current position of the air passage apparatus 1.

The inventive configuration of an actuating drive or the inventive electronic method of control of an actuating drive for an air passage apparatus for engine cooling of a vehicle enables not only simple diagnoses of malfunctions, particularly based on evaluation of determined and stored values of the determined operating variable. but also a longer service life of an air passage apparatus and the associated actuating drive, as well as possible improvement of the performance of a rotational speed control means for a drive motor of the actuating drive, and a simple means of optimization of the adjustment characteristics of the drive motor. The ability to recognize critical operating difficulties in adjustment of the air passage apparatus and to make corresponding changes in the operating parameters of the drive motor allow the load on the mechanical system and the drive motor to be reduced, and allow one to achieve more robust operation at reasonable cost in serial production, even under extreme conditions. Also, one obtains the ability to classify and thereby maximally avoid adjustment movements which contribute undesirable noises.

1-15. (canceled)

16. An actuating drive for an air passage apparatus for engine cooling in a vehicle, comprising
a drive motor for adjusting the air passage apparatus between an open position in which the air passage apparatus is maximally open for passage of an air stream and a closed position in which the air passage apparatus is closed so as to minimize an air stream, and
a control unit for controlling the drive motor, in which control unit are stored operating parameters for a first operating mode of the drive motor, in order to adjust the air passage apparatus between the open and closed position, as intended,
wherein
the actuating drive has a drive element which is drivable by the drive motor and a driven element movable along an adjustment path with the drive element for adjusting the air passage apparatus,
the drive element and the driven element are coupled together in an operating state for adjusting the air passage apparatus, and are decoupled from each other in another operating state, whereby the driven element is movable with respect to the drive element, and
the control unit is designed and configured such that
at least one operating variable of the drive motor can be determined during an adjustment of the air passage apparatus, and an evaluation can be made whether the air passage apparatus is in an operating state in which the driven element is decoupled from the drive element, and
if such an operating state is present, the drive motor is operated in at least one additional operating mode, for at least one subsequent adjustment of the air passage apparatus, wherein different operating parameters are provided for controlling the drive motor, said operating parameters being different from those in the first operating mode.

17. The actuating drive according to claim 16, wherein the control unit is designed and configured such that, after determination of the operating state in which the driven element is decoupled from the drive element, and/or after determination of another operating state, with the aid of at least one operating variable,
to operate the drive motor for the adjustment of the air passage apparatus permanently with changed operating parameters, and/or
to operate the drive motor for a period of time with operating parameters which are different from those in the first operating mode.

18. The actuating drive according to claim 17, wherein operating parameters are stored in the control unit for at least one second operating mode, so that, after determination of a particular operating state, a temporary switch may be made from the first operating mode to the second operating mode, in an adjustment of the air passage apparatus.

19. The actuating drive according to claim 16, wherein a nominal course for the at least one operating variable for adjusting the air passage apparatus in the first operating mode is stored in the control unit, and the control unit is designed and configured so as to evaluate whether a deviation from the nominal course stored for the operating variable is present.

20. The actuating drive according to claim 19, wherein the control unit is designed and configured so as to determine and evaluate the actual course of the at least one operating variable, during an adjustment of the air passage apparatus.

21. The actuating drive according to claim 20, wherein the control unit is designed and configured so that, during an adjustment brought about by the drive motor, the control unit can evaluate whether an operating state of the air passage apparatus is present wherewith the driven element is decoupled from the drive element, with the aid of the deviation of a determined actual curve of the at least one determined operating variable from a stored nominal course.

22. The actuating drive according to claim 18, wherein a nominal course for the at least one operating variable for adjusting the air passage apparatus in the first operating mode is stored in the control unit, and the control unit is designed and configured so as to evaluate whether a deviation from the nominal course stored for the operating variable is present and the control unit is designed and configured so that it can evaluate a deviation from the nominal course of the at least one operating variable as a critical operating state of the air passage apparatus, wherein a malfunction of the air passage apparatus is present, and so that said control unit can operate the drive motor automatically in another operating mode, in which adjustment of the air passage apparatus is only possible with prescribed operating parameters which are different from the operating parameters of the first operating mode, in which it is assumed that the adjustability of the air passage apparatus is error-free.

23. The actuating drive according to claim 22, wherein the control unit is designed and configured such that, in the other operating mode, depending on the determined operating state,
it increases a drive torque produced by the drive motor;
it stops an adjusting movement of the air passage apparatus and at least temporarily blocks adjustment of the air passage apparatus by means of the drive motor;
it stops an adjustment of the air passage apparatus in the direction of the open or closed position, and adjusts the air passage apparatus in the opposite direction by means of the drive motor, and/or
it automatically adjusts the air passage apparatus into the open position in which the air passage apparatus is maximally open, by means of the drive motor.

24. The actuating drive according to claim 6,
a transmission element disposed between the drive element and the driven element for establishing an operative connection between the drive element and the driven element is provided, and
an actuator which interacts with the transmission element such that, in a first actuator position of the actuator, the driven element is directly coupled to the drive element, for movement along the adjustment path, and in a second actuator position of the actuator, the driven element is movable relative to the drive element, at least when the driven element is disposed in a prescribed segment of the adjustment path.

25. The actuating drive according to claim 16, wherein the control unit is designed and configured such that it can determine and evaluate the strength of an electric current consumed by the drive motor, and/or the level of a supply voltage applied to the drive motor, and/or a rotational speed of the drive motor, as an operating variable during an adjustment of the air passage apparatus.

26. The actuating drive according to claim 16, wherein the control unit is designed and configured such that it can determine a plurality of different operating states of the air passage apparatus, with the aid of the at least one determined operating variable, particularly with the aid of the timewise course of the at least one operating variable during an adjustment of the air passage apparatus.

27. The actuating drive according to claim 16, wherein the control unit is coupled to a temperature sensor, and is designed and configured to determine whether a particular operating state is present, and/or to additionally evaluate a temperature measured by the temperature sensor for the control of a subsequent adjustment of the air passage apparatus.

28. The actuating drive according to claim 17, the control unit is additionally designed and configured such that
after the mounting of the actuating drive, it can determine first attainment of the open and/or the closed position of the air passage apparatus, in the first operating mode, with the aid of the at least one determined operating variable, and can recognize this position as an operating state in which the air passage apparatus cannot be further adjusted; and
it can permanently change the operating parameters of the drive motor depending on the determined position of the air passage apparatus, such that a subsequent adjustment of the air passage apparatus in the direction of the open or closed position will be optimized with regard to noise generation, wear, adjustment speed, and/or power consumption of the actuating drive.

29. A method for the electronic control of a drive motor of an actuating drive for an air passage apparatus for engine cooling of a vehicle, particularly an actuating drive according to claim 16, wherein a drive motor for adjustment the air passage apparatus between an open position in which the air passage apparatus for passage of an air stream is maximally open and a closed position in which the air passage apparatus is closed, to minimize the air stream, is operated in a first operating mode, wherein
the actuating drive has a drive element which is drivable by the drive motor and driven element which is movable with the drive element along an adjustment path, for adjusting the air passage apparatus;
the drive element and the driven element are coupled together for adjusting the air passage apparatus, in one operating state, and in another operating state they are decoupled from each other, so that the driven element is movable relative to the drive element;
at least one operating variable of the drive motor is determined during an adjustment of the air passage apparatus, in the first operating mode, and an evaluation is made of whether an operating state of the air passage apparatus is present in which the driven element is decoupled from the drive element; and
when such an operating state is present, the drive motor is operated in at least one additional operating mode, for at least one subsequent adjustment of the air passage apparatus, wherewith in said additional operating mode operating parameters which are different from those in the first operating mode are provided, for control of the drive motor.

30. The method according to claim 29, wherein, after the determination of the operating state in which the driven element is decoupled from the drive element, and/or after determination of another operating state, with the aid of the at least one operating variable,
the drive motor for adjusting the air passage apparatus is permanently operated with changed operating parameters; and/or
the drive motor is temporarily operated with operating parameters which are different from those of the first operating mode.
